(19) United States
(12) Patent Application Publication
(10) Pub. No.: US 2015/0359192 A1
(43) Pub. Date: Dec. 17, 2015

(54) FLEA REMOVAL DEVICE

(71) Applicants: Marlene Fanelli, Hamilton, NJ (US); David Laing, Hamilton, NJ (US)

(72) Inventors: Marlene Fanelli, Hamilton, NJ (US); David Laing, Hamilton, NJ (US)

(21) Appl. No.: 14/741,576

(22) Filed: Jun. 17, 2015

Related U.S. Application Data
(60) Provisional application No. 62/013,489, filed on Jun. 17, 2014.

(51) Int. Cl. A01K 13/00

(52) U.S. Cl. CPC A01K 13/003; A01K 13/002

(57) ABSTRACT

A flea removal device for removing undesirable material is provided. The flea removal device comprises a housing having a top surface, a bottom surface, a first side surface, a second side surface, a front end, and a rear end. A vacuum mechanism creating a vacuum at the front end of the housing. A sprayer mechanism sprays a flea eradicating liquid. A grooming comb is releasably securable to the front end of the housing. A power mechanism powers the vacuum mechanism and the sprayer mechanism. A toggle switch alternatingly switches power between a vacuum mode and a sprayer mode. Upon activation of the vacuum mechanism, the undesirable material enters the housing through the front end of the housing. Upon activation of the sprayer mechanism, the flea eradicating liquid exits the housing through the front end of the housing.

The present application claims the benefit of priority of pending provisional patent application Ser. No. 62/013,489, filed on Jun. 17, 2014, entitled “Fleaminator”.

### BACKGROUND OF THE INVENTION

1. Field of the Invention

This invention relates generally to a fleas removal device and, more particularly, the invention relates to a flea removal device providing a compact, portable handheld device for easily and effectively ridding pets of fleas, ticks, eggs, and dander.

2. Description of the Prior Art

Flea removal is a recurrent problem typically associated with the ownership of household pets. Pet owners often invest significant amounts of time and money in the continuous battle against these tiny, pesky creatures. Flea shampoos, treated collars, chemical dips, sprays, powders, combs, diet supplements, etc., are all used in what may be a futile attempt to ward off or eradicate the fleas infesting their pets.

Many of these methods for flea removal include harsh chemicals that may be dangerous not only to the pet, but to the pet owner as well. Pet owners may be unwilling to immerse their beloved pet in a vat of flea dip or douse them with a harmful powder or spray—if there is a chance of a toxic reaction to that chemical. Consequently, several devices have been patented which are designed to mechanically remove the fleas from the pet without the direct use of harsh chemicals.

For example, U.S. Pat. Nos. 4,279,095, 4,485,583, and 4,630,329 describe flea vacuum systems for removing fleas from a pet. Unfortunately, unlike the present invention, none of these references employ a unique, three-stage design that kills fleas as it combs the animal's fur, then vacuum the fur to clean and groom it thereby eliminating the need for harsh insecticides and flea-collars, while making life immeasurably better for both pets and pet owners.

### SUMMARY

The present invention is a flea removal device for removing undesirable material from a pet. The flea removal device comprises a housing having a top surface, a bottom surface, a first side surface, a second side surface, a front end, and a rear end. A vacuum mechanism creating a vacuum at the front end of the housing. A sprayer mechanism sprays a flea eradicating liquid. A grooming comb is releasably securable to the front end of the housing. A power mechanism powers the vacuum mechanism and the sprayer mechanism. A toggle switch alternatingly switches power between a vacuum mode and a sprayer mode. Upon activation of the vacuum mechanism, the undesirable material enters the housing through the front end of the housing. Upon activation of the sprayer mechanism, the flea eradicating liquid exits the housing through the front end of the housing.

In addition, the present invention includes a flea removal device for removing undesirable material from a pet. The flea removal device comprises a housing having a top surface, a bottom surface, a first side surface, a second side surface, a front end, and a rear end. A vacuum motor is mounted within the housing with a vacuum aperture formed at the front end of the housing. A collection area receives the undesirable debris from the vacuum aperture. A sprayer motor is mounted within the housing with a spray trigger mechanism operatably connected to the sprayer motor. A liquid chamber is formed within the housing with tubing extending from the liquid chamber to the front end of the housing. A grooming comb is releasably securable to the front end of the housing with a plurality of spray nozzles positioned in the grooming comb. A power mechanism powers the vacuum mechanism and the sprayer mechanism. A toggle switch alternatingly switches power between a vacuum mode and a sprayer mode. Upon activation of the vacuum motor, the undesirable debris enters the vacuum aperture and deposited in the collection area. Upon activation of the sprayer motor and manipulation of the spray trigger mechanism, the eradicating liquid in the liquid chamber travels through the tubing to the front end of the housing and out through the spray nozzles in the teeth of the grooming comb.

### BRIEF DESCRIPTION OF THE DRAWINGS

FIG. 1 is a perspective side view illustrating a flea removal device, constructed in accordance with the present invention, with a rechargeable battery pack, a power switch, and a sprayer;

FIG. 2 is another perspective view illustrating the flea removal device of FIG. 1, constructed in accordance with the present invention, with a transparent flip open lid and a detachable charger cord;

FIG. 3 is a top plan view illustrating the flea removal device of FIG. 1, constructed in accordance with the present invention;

FIG. 4 is a sectional side view illustrating the flea removal device, constructed in accordance with the present invention, with a vacuum motor, a sprayer motor, a spray trigger, locking clips for changing combs, a liquid chamber, and a transparent mesh bag for collection;

### DETAILED DESCRIPTION OF THE PREFERRED EMBODIMENTS

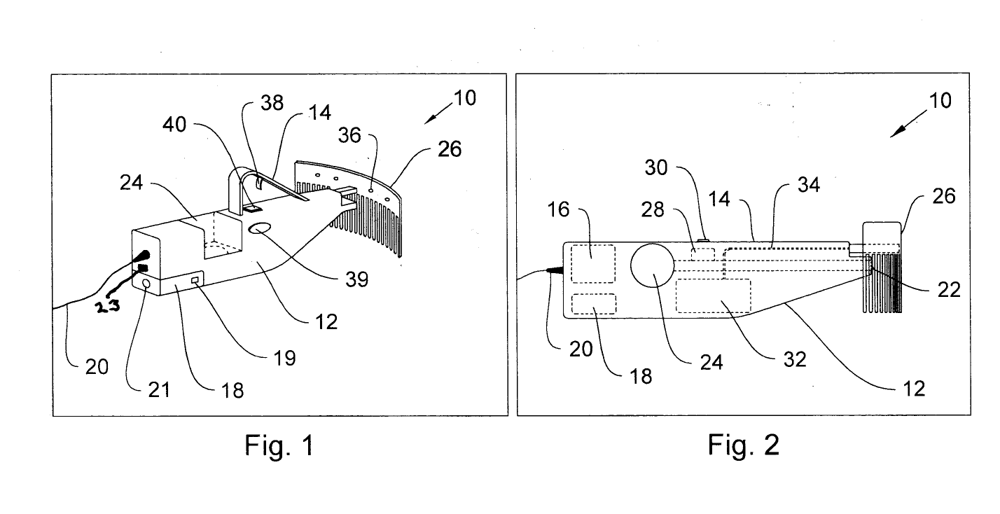

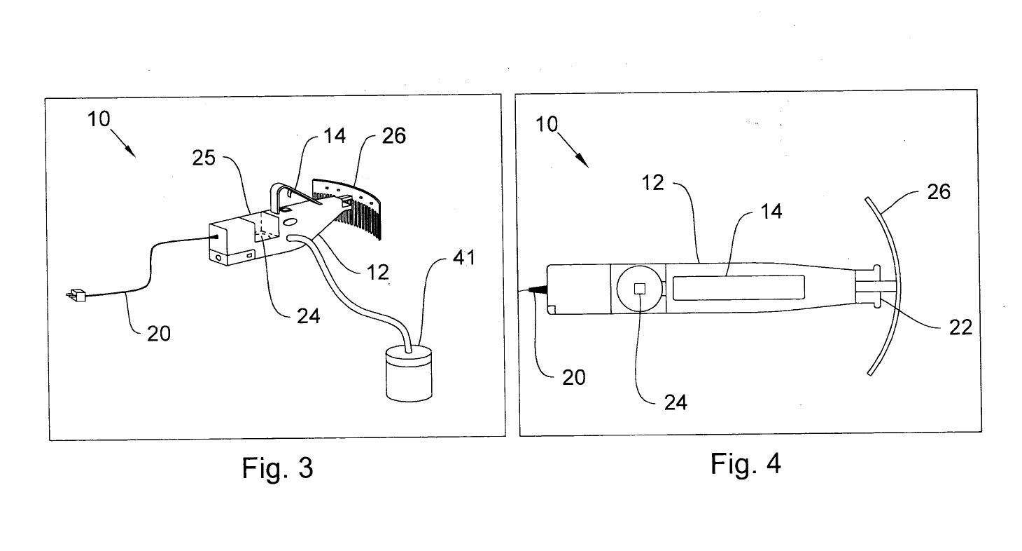

As illustrated in FIGS. 1-4, the present invention is a flea removal device, indicated generally at 10, providing a compact, portable handheld device for easily and effectively ridding pets of fleas, ticks, eggs, and dander. The flea removal device 10 of the present invention is a handheld, grip-style vacuum canister finished with a tough and durable molded thermoplastic housing 12. Although the housing 12 of the flea removal device 10 has been described as being constructed from a thermoplastic material, it is within the scope of the present invention to construct the housing 12 from other materials, including, but not limited to, metal, wood, ceramic, etc.

The housing 12 of the flea removal device 10 of the present invention has a top surface, a bottom surface, a first side surface, a second side surface, a front end, and a rear end. In a preferred embodiment, the housing 12 measures approximately ten (10″) inches to approximately twelve (12″) inches in length, with a width of approximately three (3″) inches to approximately four (4″) inches. Preferably extending from the top surface of the housing 12 is a fixed, molded, ergonomic grip handle 14 allowing a user to easily grip and thereby manipulate the flea removal device 10 during use. The grip handle 14 can be a closed loop handle, as shown, or an open handle, depending on the desires of the manufacturer and/or user.

The flea removal device 10 of the present invention includes a vacuum motor 16 preferably mounted adjacent the rear end of the housing 12. The vacuum motor 16 can be powered by alternating current, 110-volt household outlet with a power cord extending from the rear end of the housing 12 or long-life rechargeable batteries 18 preferably removably mounted near the rear end of the housing 12 on the bottom surface of the housing 12. With the rechargeable batteries 18, a charging cord 20 can be provided for recharging the batteries 18, as needed. The power cord 20 can be interchangeable for 110 v and to charge the batteries 18 via an internal converter from AC/DC with a two prong port 21 in both vacuum motor 16 and batteries 18. The power cord 20 preferably has a female two prong adaptation. An indicator light 19 (red or other preferred color) indicates when batteries 18 are low on power. In addition, a separate dual battery charging port can be provided for commercial use or for those who have many pets. a second toggle switch 23 is for alternatingly switching from AC power to DC power when using a battery or 110 v power

The vacuum motor 16 of the flea removal device 10 of the present invention, when activated, vacuums the pet through a vacuum aperture 22 formed at the front end of the housing 12, with the material collected being deposited into a hollow collection area 24. In a preferred embodiment, the collection area 24 can have a transparent flip open lid 25 for accessing a mesh bag allowing a user to view the contents of the collection area prior to retrieving. A drain outlet can be provided for the liquid in the collection area 24, under the mesh bag, through the snap connect with a check valve (that closes when the tube is disconnected to avoid seepage) via a tube into a fluid collection canister 41 with a sealed screw-on top.

In addition, the flea removal device 10 of the present invention includes a hollow-toothed grooming comb 26. In a preferred embodiment, the grooming comb 26 is curved for better contour to the shape of the pet and to avoid over spraying. The grooming comb 26 is preferably snapped into place on the front end of the housing 12 by a plurality of locking clips or other mechanical means including, but not limited to, snaps, fasteners, magnets, etc.

Furthermore, the flea removal device 10 of the present invention includes a spray device including a sprayer motor 28 mounted within the housing 12, a spray trigger mechanism 30, a liquid chamber 32 formed in the housing 12, and tubing 34 extending from the liquid chamber 32 to the front end of the housing 12. In a preferred embodiment, the spray trigger mechanism 30 is operatably mounted on an underside surface of the handle 14 facing the top surface of the housing 12 and is operatably connected to the sprayer motor 28. The trigger mechanism 30 allows a user to activate the sprayer motor 28 which causes the liquid in the liquid chamber 32 to travel through the tubing 34 to the front end of the housing 12. The liquid chamber 32 or reservoir can contain an environmentally-safe (perhaps herbal) liquid formulation designed to kill fleas, flea eggs and larvae, and ticks while not harming the host animal. Natural, organic ingredients for killing fleas include, but are not limited to, rosemary, lavender, apple-cider vinegar, lemon juice, etc. The refillable liquid chamber 32 is concealed within the housing 12 and can be equipped with a gasketed snap-cap 39 mounted on the side of the housing 12 allowing the user to seal the liquid chamber 32 and maintaining the liquid therein with minimal leakage. The liquid flea-killer solution is pumped from the liquid chamber 32 through the tubing 34 within the housing 12 to a nipple-style nozzle-fitting at the front end of the housing 12 and out through the hollow teeth of the comb 26, through the pet's fur, and onto its skin.

Further yet, in an embodiment of the flea removal device 10 of the present invention, a toggle switch 38 is mounted to the handle 14. The toggle switch 38 allows a user to alternatingly choose between vacuum mode and sprayer mode with a back position being the vacuum mode, the center position being an off mode, and a forward position being a spray mode. When the toggle switch 38 is positioned in the vacuum mode, the vacuum is operatable to remove the fleas from the pet. When the toggle switch 38 is positioned in the sprayer mode, the spray device is operatable to spray flea killer liquid onto the pet.

The flea removal device 10 of the present invention further includes an On/Off switch 40 preferably mounted to the top surface of the housing 12 or on a topside surface of the handle 14. Depending on the position of the toggle switch 38, the On/Off switch 40 will activate either the vacuum motor 16 or the sprayer motor 28 for use in removing fleas from the pet.

The manner of use of the flea removal device 10 of the present invention will now be described. It will be understood by those skilled in the art that the manner of use of the flea removal device 10 described herein is merely one method of use and other methods of use of the flea removal device 10 are within the scope of the present invention.

First, in the use of the flea removal device 10 of the present invention, the user activates the flea removal device 10 by activating the On/Off switch 40 to the on position. Toggling the toggle switch to the sprayer position, the user activates the sprayer motor 28 thereby activating the spray mechanism with the manipulation of the trigger mechanism 30. The liquid flea-killer solution is pumped through the tubing 34 from the liquid chamber 32 to the nozzle-fitting at the front end of the housing 12 with the flea-killer solution applied through the teeth of the comb 26, through the pet's fur, and onto its skin. The user then simply combs the pet's fur, squeezing the trigger mechanism 30 to dispense the solution deeply and evenly. After the solution has been applied and given a few minutes in which to work, the user toggles the toggle switch 38 to the vacuum position then squeezes the trigger mechanism 30 to vacuum the pet. The spray-applicator comb 26 is now changed for a vacuum comb 26, and the vacuum comb 26, similarly equipped with hollow teeth, but of a larger diameter, is snapped into place onto a receiver fitting at the first end of the housing 12. With the toggle switch 38 switched to the vacuum position, the user will simply groom the pet's fur once more with the vacuum comb 26 now extracting up dead fleas, eggs, larvae, and ticks as well as removing flea-dirt and dander from the animal's fur and skin. The vacuumed material is collected in a clear plastic, snap-in/snap-out collection area 24 near the rear of the handle 14. The compartment 24 can accommodate a disposable liner or collection bag which is also impregnated with the flea-killer solution; and the snap-out feature makes for quick and easy disposal of the contents. The user will repeat the spray-and-vacuum procedure as necessary to fully rid the animal of parasites. Please note that after the initial spray, the vacuum step may be sufficient without further application of the liquid spray. In addition, wet wipes with the same flea killing solution could be produced in this line for use in touch-up applications when necessary.

Preferably, each flea removal device 10 of the present invention includes a pair of spray-combs and a pair of vacuum-combs in fine-tooth and wide-tooth versions, a starter bottle of flea-killer solution; and approximately fifteen (15) vacuum liner bags. The curved combs are preferably available in different tooth sizes for short hair, thick hair, and long hair pets. The flea removal device 10 thus presents itself as a well-designed, all-in-one system for ridding a pet of fleas, eggs, larvae, and ticks with a system that will be gentle on the pet and on the environment, and death to fleas. The flea removal device 10 not only kills fleas effectively but also removes them, as well as eggs, flea-dirt, and larvae while grooming the animal's fur. The flea removal device 10 enables pet owners to care effectively for their pets without the need for harsh chemical insecticides that hurt the pet while killing the fleas.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A flea removal device for removing undesirable material from a pet, the flea removal device comprising:
a housing having a top surface, a bottom surface, a first side surface, a second side surface, a front end, and a rear end;
a vacuum mechanism creating a vacuum at the front end of the housing;
a sprayer mechanism for spraying a flea eradicating liquid;
a grooming comb releasably securable to the front end of the housing;
power means for powering the vacuum mechanism and the sprayer mechanism; and
a toggle switch for alternatingly switching power between a vacuum mode and a sprayer mode;
wherein upon activation of the vacuum mechanism, the undesirable material enters the housing through the front end of the housing; and
wherein upon activation of the sprayer mechanism, the flea eradicating liquid exits the housing through the front end of the housing.

2. The flea removal device of claim 1 wherein the undesirable material is selected from the group consisting of fleas, ticks, eggs, and dander.

3. The flea removal device of claim 1 and further comprising:
a handle extending from the top surface of the housing.

4. The flea removal device of claim 1 wherein the vacuum mechanism comprises:
a vacuum motor mounted within the housing;
a vacuum aperture formed at the front end of the housing; and
a collection area for receiving the undesirable debris from the vacuum aperture;
wherein upon activation of the vacuum motor, the undesirable debris enters the vacuum aperture and deposited in the collection area with the waste liquid being removed and collected into a separate collection canister.

5. The flea removal device of claim 4 wherein the vacuum motor is powered by a power source selected from the group consisting of alternating current, 110-volt household outlet with a detachable power cord extending from the rear end of the housing and rechargeable batteries removably mounted near the rear end of the housing on the bottom surface of the housing, the power cord further used for battery charging with an internal power converter for DC power, and further comprising a separate dual battery charger.

6. The flea removal device of claim 4 wherein the collection area can include a transparent mesh bag.

7. The flea removal device of claim 1 wherein the grooming comb is a hollow-toothed grooming comb, the flea eradicating liquid exiting the front end of the housing and dispensed through the grooming comb.

8. The flea removal device of claim 1 wherein the grooming comb is releasably snapped into place on the front end of the housing by a plurality of locking clips.

9. The flea removal device of claim 1 wherein the sprayer mechanism comprises:
a sprayer motor mounted within the housing;
a spray trigger mechanism operatably connected to the sprayer motor;
a liquid chamber formed within the housing; and
tubing extending from the liquid chamber to the front end of the housing;
wherein upon activation of the sprayer motor and manipulation of the spray trigger mechanism, the liquid in the liquid chamber travels through the tubing, and out of the front end of the housing.

10. The flea removal device of claim 9 wherein the liquid chamber includes a gasketed snap-cap for sealing the liquid chamber.

11. The flea removal device of claim 9 and further comprising:
a plurality of spray nozzles positioned in the grooming comb;
wherein the eradicating liquid pumped from the liquid chamber through the tubing within the housing to a nipple-style nozzle-fitting at the front end of the housing and out through the teeth of the comb.

12. The flea removal device of claim 1 wherein the flea eradicating liquid is selected from the group consisting of rosemary, lavender, apple-cider vinegar, and lemon juice, etc.

13. A flea removal device for removing undesirable material from a pet, the flea removal device comprising:
a housing having a top surface, a bottom surface, a first side surface, a second side surface, a front end, and a rear end;
a vacuum motor mounted within the housing;
a vacuum aperture formed at the front end of the housing;
a collection area for receiving the undesirable debris from the vacuum aperture;
a sprayer motor mounted within the housing;
a spray trigger mechanism operatably connected to the sprayer motor;
a liquid chamber formed within the housing;
tubing extending from the liquid chamber to the front end of the housing;
a grooming comb releasably securable to the front end of the housing;
a plurality of spray nozzles positioned in the grooming comb; and
power means for powering the vacuum mechanism and the sprayer mechanism;
a first toggle switch for alternatingly switching power between a vacuum mode and a sprayer mode;
a second toggle switch for alternatingly switching from AC power to DC power when using a battery or 110 v power;
wherein upon activation of the vacuum motor, the undesirable debris enters the vacuum aperture and deposited in the collection area;
wherein upon activation of the sprayer motor and manipulation of the spray trigger mechanism, the eradicating liquid in the liquid chamber travels through the tubing to the front end of the housing and out through the spray nozzles in the teeth of the grooming comb.

14. The flea removal device of claim 13 wherein the undesirable material is selected from the group consisting of fleas, ticks, eggs, and dander.

15. The flea removal device of claim 13 and further comprising:
a handle extending from the top surface of the housing.

16. The flea removal device of claim 13 wherein the vacuum motor is powered by a power source selected from the group consisting of alternating current, 110-volt household outlet with a detachable power cord extending from the rear end of the housing and rechargeable batteries removably mounted near the rear end of the housing on the bottom surface of the housing, the power cord further used for battery charging with an internal power converter for DC power, and further comprising a separate dual battery charger.

17. The flea removal device of claim 13 wherein the collection area can include a transparent mesh bag.

18. The flea removal device of claim 13 wherein the grooming comb is a hollow-toothed grooming comb, the flea eradicating liquid exiting the front end of the housing and dispensed through the grooming comb.

19. The flea removal device of claim 13 wherein the grooming comb is releasably snapped into place on the front end of the housing by a plurality of locking clips.

20. The flea removal device of claim 13 wherein the liquid chamber includes a gasketed snap-cap for sealing the liquid chamber.
